(19) United States
(12) Patent Application Publication
(10) Pub. No.: US 2004/0078388 A1
(43) Pub. Date: Apr. 22, 2004

(54) Computer-implemented method and system for browsing directories and generating forms

(76) Inventor: Haim Zvi Melman, Kfar-Saba (IL)

Correspondence Address: Haim Melman, 3 Hagai St., Kfar-Saba, 44335, IL

(21) Appl. No.: 09/816,462

(22) Filed: Mar. 23, 2001

(51) Int. Cl. G06F 7/00

(52) U.S. Cl. 707/104.1

(57) ABSTRACT

A method is provided to display a directory containing a list of items. A minimized representation of the items can be extracted by the user for a first evaluation of the items. Following a selection of the desired items more comprehensive representations are generated. These representations contain item information and means to communicate with other parties. The system also provides means for creating the representation of the items that do not require a direct access to the database of the directory.

### FIELD OF THE INVENTION

This invention relates to electronic directories and man-computer interface thereby. More specifically, the investment relates to browsing through items listed in such directories the handling of information related to such items.

### BACKGROUND OF THE INVENTION

During the last years electronic telephone directories (directories) have been offered over the World Wide Web (Web) and in other forms such as compact disks storage media and proprietary on-line services.

Although not implemented in the same way in different directories, all methods replicate the approach of combining basic listing of items with the addition of extended advertising of some of the items for fees. Such a listed item may consist of a name, address and phone number of a vendor of a service. The associated extended advertisement may include more information such as a detailed description of the service, weekly availability hours, pictures and credit payment information. Owners of listed items are willing to pay for Expanded Ad since such ads attract more contacts from potential customers and increase the revenues for the business.

Acco0rding to the present state of the art the different directories offered in the market offer such Expanded Ad independently. If a business owner wants to have his Expanded Ad in few different directories that are published by different entities, he will have to buy this service from each directory separately. This approach is also the current directory market standard. Selling Expanded Ads is one of the most important revenue resources for directory publishers. Publishers compete to gain the AE business for their directories.

As for the customer, purchasing an Expanded Ad is expensive. Many businesses do not purchase Expanded Ads at all due to the high costs. Purchasing AE in more then one directory is too expensive for most of the businesses and thus, utilized mainly by big and wealthy organizations.

LookSmart, Ltd., of San Francisco, Calif., USA (www.looksmart.com/1&tunnel=businesses.html) is one example of a Web based directory. A page of the directory of LookSmart, Ltd. is divided to two sections (displayed simultaneously on one page). The top section displays Expanded Ads and the lower section displays the basic listing of suppliers. The Expanded Ad price may based on parameters such as location in the list and coverage area. The closer the Expanded Ad is to the top of the list and the larger it is—the more expensive it is to buy that AE.

Infospace, Inc. of Bellevue, Wash., USA (www.infospace.com) is another example for yellow-pages service that does not provide Expanded Ads directly. Instead the user has to click a button available with the basic record list and then get an Expanded Ad from LookSmart, Ltd., if such an Expanded Ad exists at LookSmart. If a customer is purchasing an Expanded Ad at any of LookSmart, Ltd. or Switchboard, Inc. of Westboro, Mass. (www.switchboard.com), this will not be enough to have his Expanded Ad displayed on both directories. For that he will have to purchase two Expanded Ads, one at each directory publisher.

It is desired therefore that when a customer purchases an Expanded Ad, the Expanded Ad will be available in any directory in which the customer's business is listed. The management of such an Expanded Ad agreement and the cost to the customer will decrease in a dramatic way.

Another aspect of using directories is related to notes and organization of information by the user. This aspect is especially evident when using yellow-pages of any form, digital or printed media. When using yellow pages to find a supplier or a specific product the user may write notes to himself These notes normally include prices, availability of the product and other details. A pen and paper are typically used to write the notes. This requires extra arrangements by the user. The relation of the notes to the specific directory item requires user attention and management. When researching the market over a period of time, the management of the information may become annoying and disordered.

Directories containing product for sale are often arranged in a similar manner to telephone directories. They are composed from a list of items. Such catalogs are used, for example, by agents that browse the catalog to select products, offering them to their clients. The evaluation is done by loading a relatively large file describing the product. This file consumes plenty of real estate of the display means and it is inconvenient to compare, sort and choose the preferred products. After selecting the preferred products they create a proposal for the client. This is also made usually by separate forms that allow them to add their notes, discounts and other communication typical to distributor/customer negotiation.

It is desired to combine, with a directory, a system that will provide the user with integrated support and easy management of the information.

### SUMMARY OF THE INVENTION

It is a particular objective of the present invention to provide a computer implemented method that enables an Expanded Ad to be presented using any directory that contains reference to the business associated with the Expanded Ad. In the suggested method, the method does not have to be implemented by a publisher of a directory or using any directory technology. It can be implemented independently using any database.

It is also a particular objective of the present invention to provide tools that will enable easy management and utilization of information related to items listed in a directory. Phone numbers, location of a store, price and availability of a product from a vendor are such typical information data collected by a user of a yellow-pages.

In one preferred embodiment of the invention a database of Expanded Ad is maintained on a server, the server being accessible via network such as the Internet. Each Expanded Ad in the database is referable by the telephone number of the business of that Expanded Ad. Client software is available for users. This software can be download to their computers and installed there. When displaying a directory page, the user may click on a telephone number of a listed item. The client software senses this action and starts a process of analysis of the displayed page to extract that telephone number. The client software then sends the extracted number to the server in which the number is compared with the telephone numbers stored in the database of that server. If the telephone number is stored in the database of the server and the number is associated with an Expanded Ad that is also stored in the server, then the server sends the Expanded Ad to the user's computer. Then, at the user's computer, the software client displays the Expanded Ad in a dedicated window.

In yet another embodiment of the invention the title of the listed item (such as the name of a business) may be used instead of the telephone number.

In another embodiment of the invention, such a dedicated window for presenting an Expanded Ad may also include a “type-in area” available for the user to type notes. This can be used by the user to add information that is not on the Expanded Ad such a summary of his phone conversation with the store or the service provider of the Expanded Ad.

In yet another embodiment of the invention one or more Expanded Ad that have are displayed in the process of search for a service may be saved as a search session for later use.

In yet another embodiment of the invention, when a product directory is used, the detailed product page is used to create a secondary page containing just a part of the information contained in the product page. Other necessary elements that are not included in the product page are added to the secondary page. Thus, the secondary page assumes a form and functionality that is useful to compare and select one ore more products. It may also assume the form and functionality required by a distributor of the product and his customer to negotiate and discuss the deal they contemplate, using these secondary pages for communication and documentation of the process, including a final quotation and order form.

The invention will be described in reference to windows 98 and Windows NT, both available from Microsoft, Inc. Redmond, Wash., USA. The interpretation of terms on methods should be done accordingly.

### A BRIEF DESCRIPTION OF THE DRAWINGS

The invention is described in more detailed with regard to the following figures:

FIG. 1A: An example of a present art online-telephone-directory displaying Expanded Ad with the standard listing.

FIG. 1B: An example of the same page of FIG. 1A displaying a lower part of the page with out Expanded Ads.

FIG. 2: An example of a present art online-telephone-directory displaying standard listing only.

FIG. 3: A schematic presentation of the main components of the present invention.

FIG. 4: An example of present art interface for composing a search query for phone directory.

FIG. 5: A schematic representation of a visual display, provided by the present invention.

FIG. 6: An example for a visual display provided by the present invention.

FIG. 7A: An example of functionality available within a window of the present invention.

FIG. 7B: An example of Save Session functionality available within a window of the present invention.

FIG. 8: An example of more functionality available within a window of the present invention.

FIG. 9: An example of a record printout provided by the present invention.

FIG. 10: A modified version of FIG. 3 providing another system configuration of the present invention.

### DETAILED DESCRIPTION OF PREFERRED EMBODIMENTS

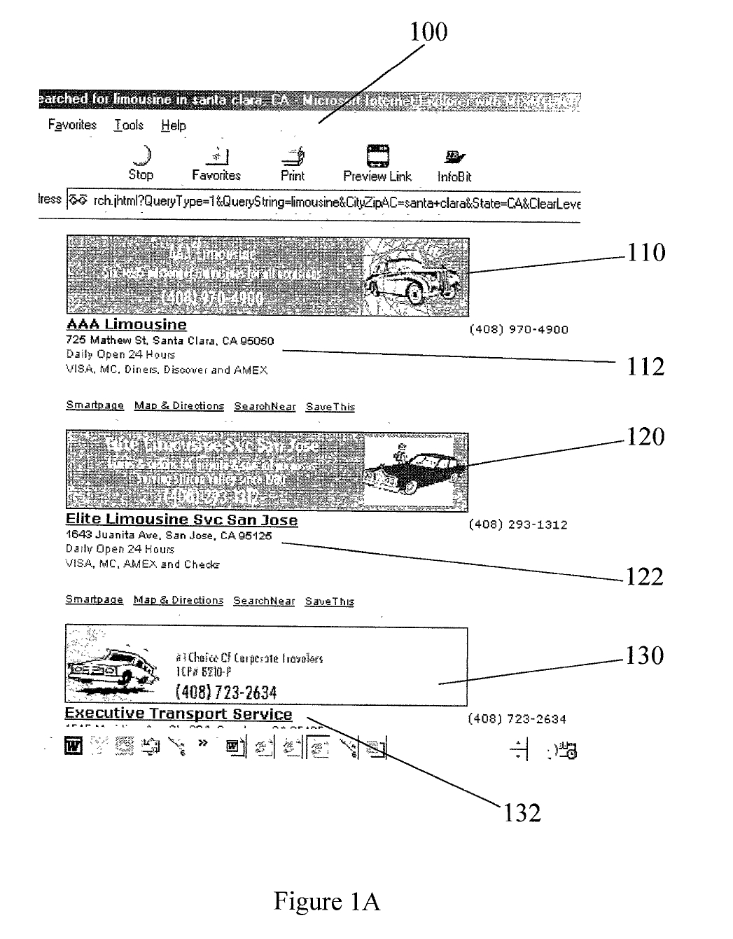

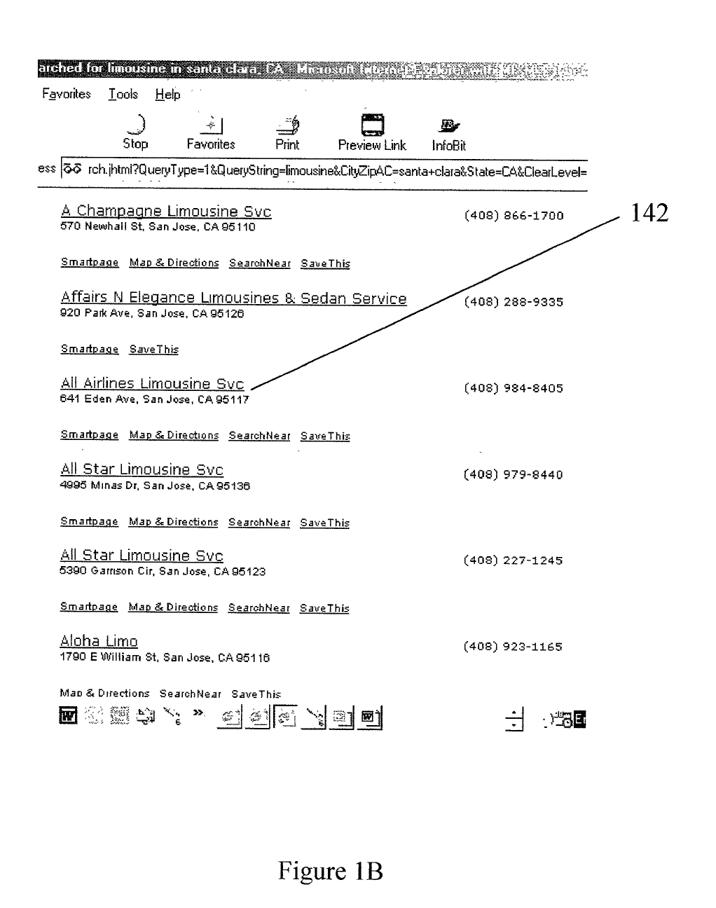

Reference is made to FIG. 1A, describing a state of the art online yellow pages directory. The example is a section of the directory of LookSmart, Ltd. A part of the browser, 100, is visible at the top of FIG. 1. The part of the html page is shown demonstrates three Expanded Ads 110, 120 and 130. In this Example, each of the Expanded Ads is located just above the standard information item 112, 122 and 132 respectively (fully visible only for the 112 and 122). FIG. 1B illustrates a lower part of the same html page of LookSmart, Ltd. In this part the directory lists items of business that have not purchased Expanded Ads. Thus only basic “standard” information is provided. For example, All Airlines Limousine Svc (associated with numerical reference 142) is listed by business name, address and phone number. No Expanded Ad is available to the user even if the same business owns an Expanded Ad wit another online yellow pages service.

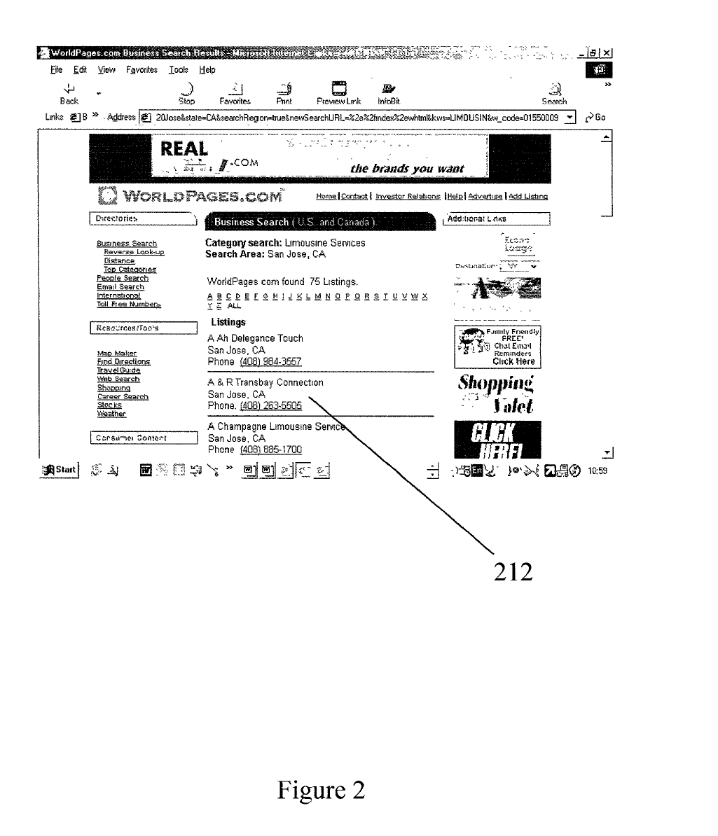

FIG. 2 presents a part of a page of WorldPages.com of San Francisco, Calif. (www.worldpages.com). Also in this example only the basic information is provided. For example, if A & R Transbay Connection (associated with numerical reference 212) owns an Expanded Ad with another directory, this Expanded Ad is not presentable with the WorldPages.com directory.

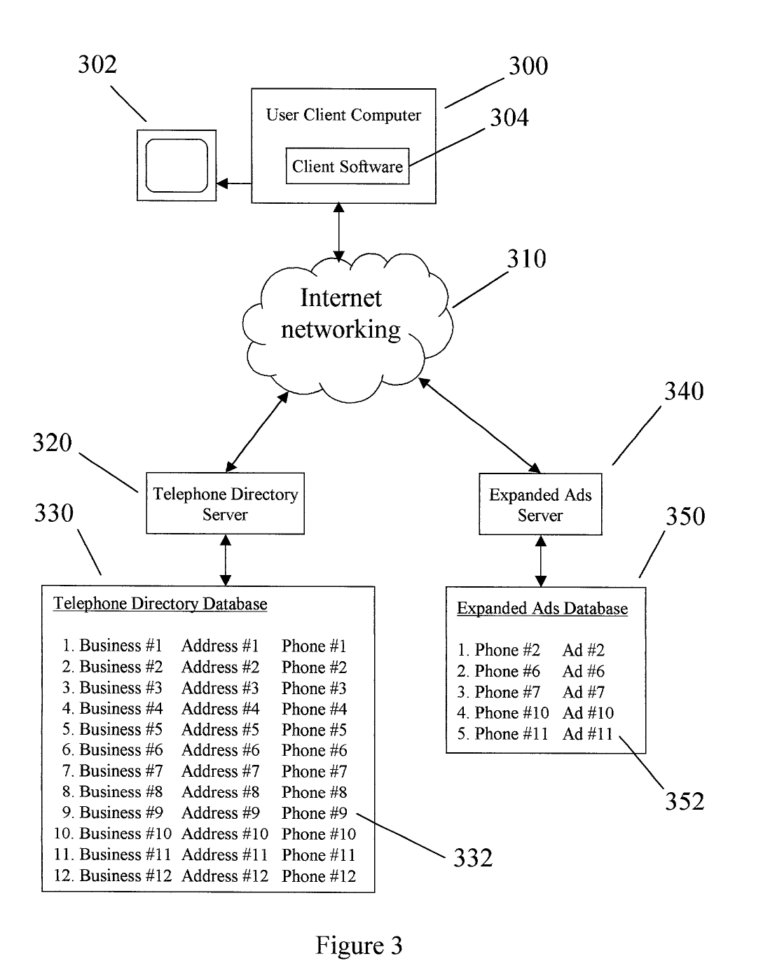

Reference is made now to FIG. 3 describing the basic concepts of one embodiment of the present invention. In the embodiment example of FIG. 3 the networking is based on the Internet indicated by numerical reference 310. Also, this example will demonstrate yellow pages directories. The User Client Computer is indicated by numerical reference 300 and it include a display device 302 and dedicated client software 304. Computer 300 is used to retrieve and display telephone directory pages. This is normally done by delivering a query to a preselected telephone directory server such as 320 of FIG. 3.

Telephone Directory Server 320 represents servers such as are used by LookSmart or WorldPages to communicate pages containing business listings to clients such as computer 300. Telephone Directory Server 320 is associated with Telephone Directory Database 330. This directory may consist of any database technology such as SQL Server available from Microsoft, Inc. Telephone Directory Database 330 contains records holding basic information for many businesses: Name of the business, address and telephone number. Such databases may contain hundreds of thousands or many millions of such records. In the example of FIG. 3, twelve records are shown whereas record number 9 is indicated by reference number 332. Record number 9 contains business name (Business #9), the address of that business (Address #9) and the telephone number of that business (Phone #9).

Expanded Ads Server indicated by numerical reference 340 is associated with Expanded Ads Database indicated by numerical reference 350. Expanded Ad Database 350 contains records (in these example 5 records) holding the Expanded Ads information. Record number 5 (indicated by numerical reference 352) contains a telephone number of a business (Phone #11) and an Expanded Ad number of that business (Ad #11). The same notation (Phone #11) is used both for the telephone number of record 5 in Expanded Ad Database 350 and the telephone number of record 11 of Telephone Directory Database 330. This is for the purpose of indication that these are the same real telephone numbers. For example, if the telephone number of record 11 in Telephone Directory Database 330 is (408) 517-1417, then also the telephone number of record 5 of Expanded Ad Database 350 will be (408) 517-1417. Ad #11 of record 5 of Expanded Ad Database 350 describes the business of record 11 of Telephone Directory Database 330. This annotation method holds for all records in the examples presented hereby.

The numerical reference numbers are constructed so that the last 2 digits refer to an item in a figure while the other digits refer to the figure number. For example numerical reference number 340 points to an item in FIG. 3. Following this methodology will make reading and reference to figures easier.

The Internet 310 is the common communication network for Telephone Directory Server 320, Expanded Ad Server 340 and the User Client Computer 300.

The system described in FIG. 3 of the present embodiment is configured to operate as described hereinbelow, step by step:

1. The user of User Client Computer 300 enters a site of yellow pages such as WorldPages.com.

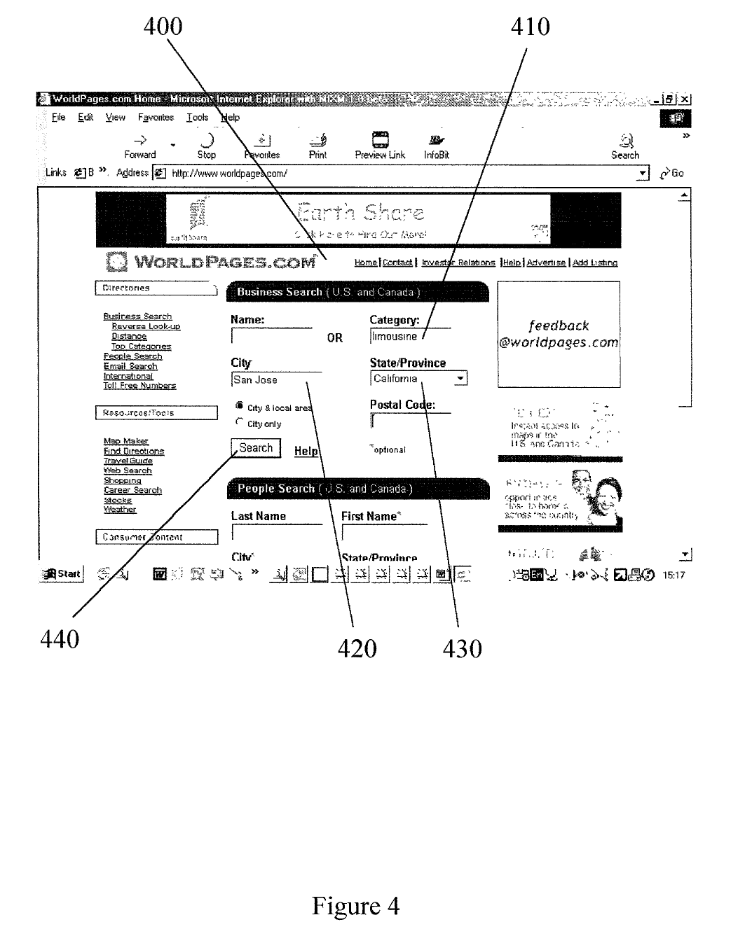

2. As a result, the html page is loaded to User Client Computer 300 and is presented on the display device as shown in FIG. 4.

3. The user may then input his request for yellow pages listing. In the example of FIG. 4 the user may type the word “Limousine” in text window 410 intended for the category of the service he is looking for, the words “San Jose” in text window 420 intended for the city in which the user wants to purchase the service and select “California” in window 430 to indicate the state.

4. Then by clicking on the “Search” button 440 and following the procedure of WorldPages.com the user provides Telephone Directory Server 320 with a query that can be interpreted by Telephone Directory Server 320.

5. As a response to the user's query Telephone Directory Server 320 searches Telephone Directory Database 330 to find records that comply with that query.

6. The records that are found are consolidated by Telephone Directory Server 330 into an html page in the form demonstrated by FIG. 2.

7. TDS delivers that page to User Client Computer 300.

8. User Client Computer 300 then displays the received html page on the display device 302.

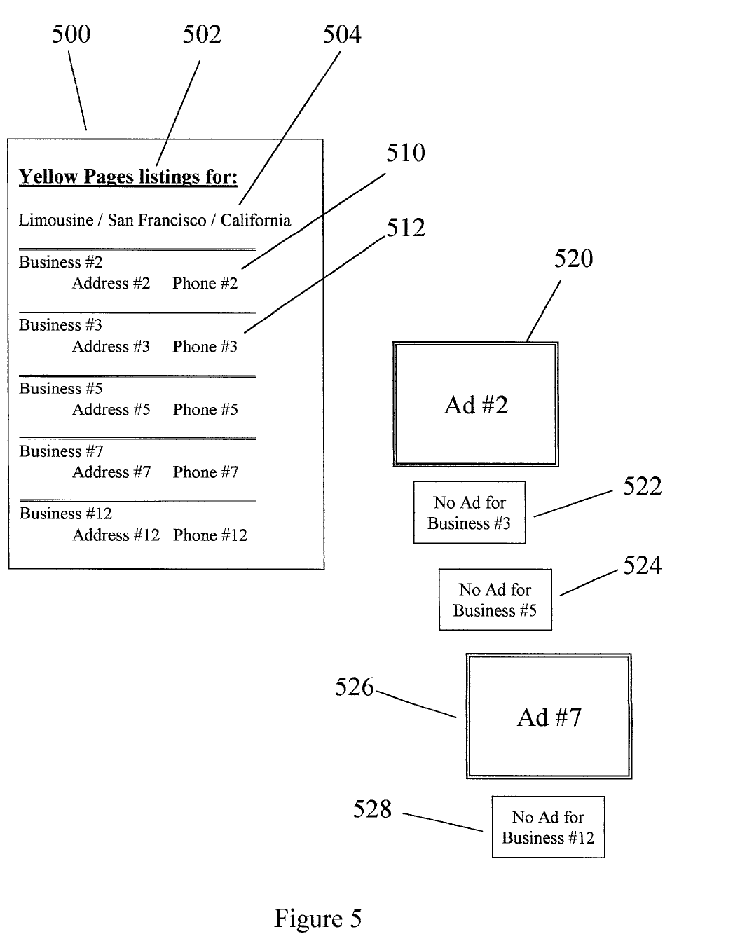

The information displayed on display device 302 will be described schematically in FIG. 5.

Listing 500 is a schematic representation of the list provided to User Client Computer 300 by Telephone Directory Server 320 as response to the user's query. A title is provided (502) and a brief presentation of the query is provided (504). Below, five of the twelve records of Telephone Directory Database 330 are listed. Only the records that comply with the query are presented.

9. The user now clicks on phone number 510 (Phone #2). The click may be a simple computer mouse click. To avoid possible hyperlink action that may result in many html pages a right button click can be used or a click combined with a keyboard key hold-down or any other distinguishing method.

10. As a result of this action Client software 304 extracts telephone number 510 in an alphanumeric digital form available for further software processing.

11. User Client Computer 304 is now delivering Phone #2 in the alphanumeric form from User Client Computer 300, via Internet networking 310 to Expanded Ad Server 340.

12. EAS 340 compares Phone #2 to the list of phone numbers in Expanded Ad Database 350 and finds it in Expanded Ad Database 350 record number 1.

13. EAD 350 now delivers the file containing Ad #2 (which is associated with Phone #2 in Expanded Ad Database 350) to User Client Computer 300 via Internet network 310.

14. User Client Computer 300 receives Ad #2 and then User Client Computer 304 presents Ad #2 in a dedicated window on display means 302.

15. The user may now select the second business in listing 500 such as Business #3 (numerical reference 512).

16. The system repeats steps 10-12 above except that Phone #3 is not found in Expanded Ad Database 350.

17. As a result Expanded Ad Server 340 is sending a message to User Client Computer 300 that an Expanded Ad is not available to that phone number.

18. User Client Computer 304 then displays message 522 on display means 302, saying that an Expanded Ad is not available for Business #3.

The user can repeat the procedure for each of the records displayed in list 500. This will result in the display of Ad #2, Ad #7 (numeric reference 526)and “no ad” messages for Business #3, Business #5 and Business #12 (numeric references 522, 524 and 528 respectively).

It is appreciated that the user may select only part of the records displayed in list 500 and in arbitrary order. Also, if he clicks more then once on the same telephone number, User Client Computer 304 may generate a sound indicating that the Expanded Ad is already displayed or that the “no ad” message is already displayed.

It is also appreciated that the method described hereinabove is independent of the specific yellow page. The method can work with a yellow page of any yellow pages vendor, as long as it is provided in a format readable by the client (such as HTML or Text files). Thus, a single Expanded Ad can be displayed with any telephone directory without need for special adjustments.

The following is a preferred embodiment for extracting a phone number by User Client Computer 304 (technology: C++, COM technology):

1. Get the Active Document (CComQIPtr<IHTMLDocument2, &IID_IHTMLDocument2>spHTML;)

2. Get the current selection (hr=spHTML>get_selection(&SelObj); )

3. Create Text Range (hr=SelObj->createRange(&Range);)

4. Get The html text for the selected portion of the document TxtRange->get₁₃htmlText(&Text);

5. Analyze the syntax of the selected portion using CString manipulation functions

6. Extract all telephone numbers from the selected portion

In another embodiment of the invention the user does not have to click on the telephone number. Instead the User may click on any text element of the displayed record. In the example of WorldPages.com, the record for A & R Transbay Connection (212) has the following html source form:

<TD>
<FONT FACE=Geneva,Arial,Helvetica SIZE=“−1”>
A & R Transbay Connection<BR>
San Jose, CA<BR>
Phone: <A HREF=http://call.click2talk.net2phone.com/cgi-
bin/c2tdial.cgi?name=Call+A%20%26%20R%20Transbay%20Connection
&number=(408)263-5505&key=W22452PU&img=world&ext=x.n2p
TITLE=“Click to Talk”>(408) 263-5505</A>
</TD><TD WIDTH=100 ALIGN=center VALIGN=top></TD>
</TR>

Any Click in the text area is equivalent to a click within the source text range that is underlined for clarification purposes.

The basic algorithm for extracting the telephone number (any of the two that are marked with double underline) can be adapted to the current embodiment of the invention by simply starting with a search forward in the text for the first 5 characters in the form (n₁n₂n₃) where n₁, n₂ and n₃ are any of 0, 1, 2, 3, . . . , 9. After finding the first occurrence of such a text structure the algorithm of the previous embodiment can be applied.

In yet another embodiment of the present invention, the process of extracting and displaying of the Ads following step 8 above is automatic.

Following step 8 above User Client Computer 300 has just completed the display of business listing 500 on display means 302. At this point the following process takes place:

1. User Client Computer 304 analyses the html file of list 500 to extract all telephone numbers in that list.

2. The telephone numbers are delivered to Expanded Ad Server 340 in the form suitable for further software processing.

3. EAS 340 compares the list of telephone numbers to the list included in Expanded Ad Database 350.

4. For each telephone number found in Expanded Ad Database 350, Expanded Ad Server 340 delivers the associated Expanded Ad to User Client Computer 300.

5. User Client Computer 304 then presents the ads on display means 302.

As a result, in this embodiment the user is being provided with a display of the complete set of available Expanded Ad immediately after the search result of the yellow pages has been displayed.

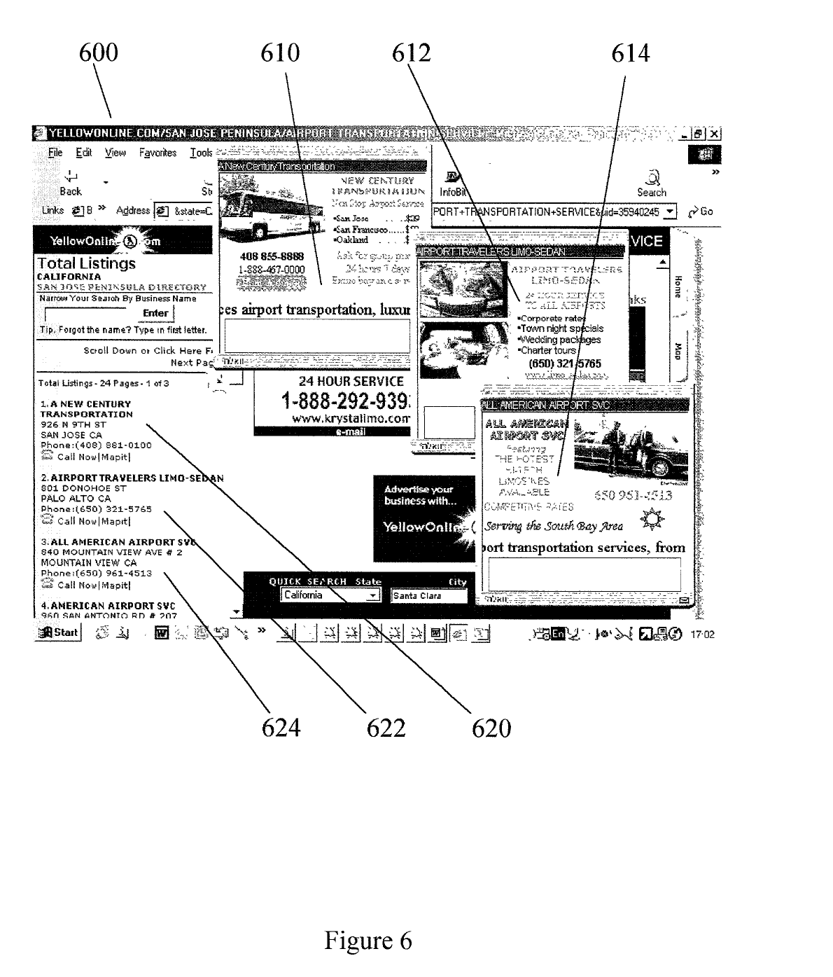

According to the following embodiment of the invention the Expanded Ad are displayed in dedicated windows, each such window contains a single Expanded Ad. An example for such a presentation is provided in FIG. 6.

In this example a yellow page listing of YellowOnline.Com Yellow Pages, Inc. of Los Angeles, Calif. is presented in Internet browser 600. Three records are fully visible at the left-bottom side of the page: A New Century Transportation, Airport Travelers Limo-Sedan and All American Airport SVC (indicated by the numerical references 620, 622 and 624 respectively).

EA associated with these records are displayed generally on the right top, each in a dedicated window. The Expanded Ad in window 610 is the Expanded Ad associated with record 620, the Expanded Ad in window 612 is the Expanded Ad associated with record 622 and the Expanded Ad in window 614 is the Expanded Ad associated with record 624. These windows are created by standard technology such as Windows 98 available from Microsoft, Inc. A complete software client demonstrating these capabilities is named PreviewLink, and is available upon request from InfoBit, Ltd. (www.infobit.com), Petach-Tikva, Israel.

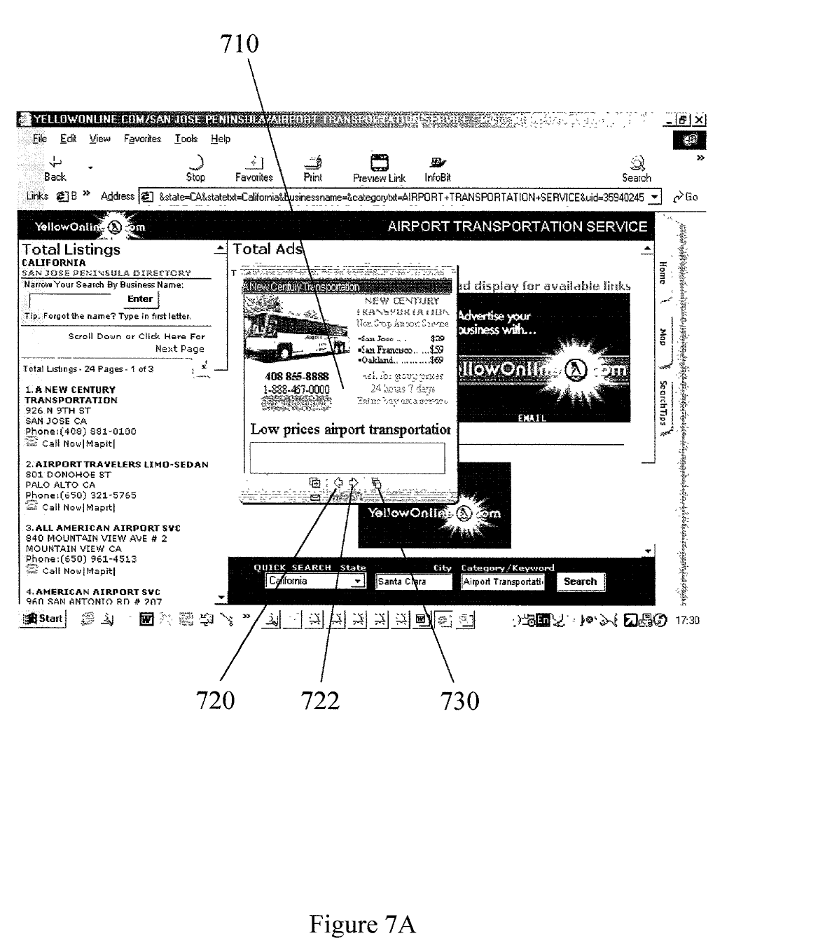

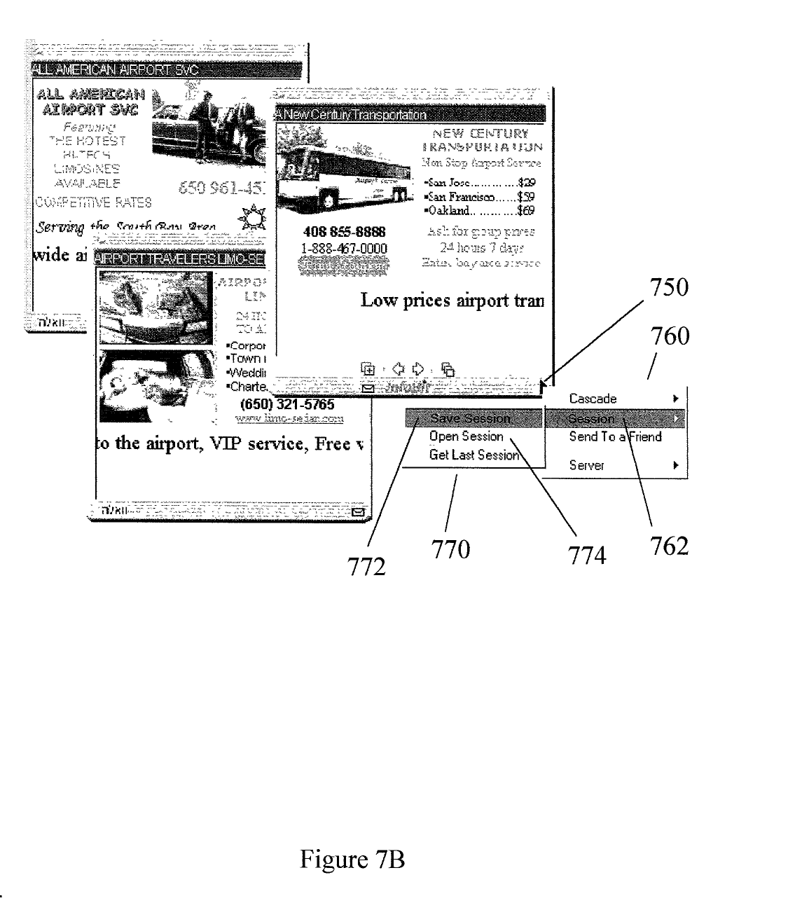

In yet another embodiment of the invention all the Expanded Ad are accumulated at the cache memory of User Client Computer 300 and only one Expanded Ad is displayed at a time as shown in FIG. 7A, numerical reference 710. This is done using Internet Explorer 5 technology of Microsoft. The user may flip between the Expanded Ad clicking on the arrow-buttons 720 and 722 (backwards and forward respectively). By clicking on the cascade-button 730 the user may change to a display in which all the Expanded Ad stored in the cache memory of User Client Computer 300 are displayed, each in a dedicated window (as in FIG. 6), all cascaded over the display area. This feature is also operative and available in the PreviewLink client of InfoBit.

Another embodiment of the present invention provides for saving information as described in reference to FIG. 7B. In the example of FIG. 7B three Expanded Ads are shown as displayed on display means 302. in FIG. 7B the yellow-page background (presented in FIG. 7A) is eliminated for convenience. If the user wants to save the three windows for a later use (for example—he may want to call the businesses later), he may follow the following steps:

1. Click on pull-down-menu-button 750 to get menu 760.

2. From menu 760 select “Session” (762) to get a sub-menu 770.

3. In sub-menu 770 select “Save Session” option (772).

4. A standard save window will open and the session can be saved at a desired location and under desired name.

The saved session may be retrieved by the following steps:

1. Click on pull-down-menu-button 750 to get menu 760.

2. From menu 760 select “Session” (762) to get a sub-menu 770.

3. In sub-menu 770 select “Open Session” option (774).

4. A standard open-file window will open and the session can be browsed for and selected.

5. The saved session will be opened and resume the same appearance and display layout it had when it was saved.

It will be appreciated that a session may be saved (or retrieved) at User Client Computer 300 or at any other location such as Expanded Ad Server 340. The save-session and open-session are operative with PreviewLink software client of InfoBit, Ltd. Petach-Tikva, Israel and is available upon request.

It will also be appreciated that the saving of session may include the telephone numbers that were used to receive the Expanded Ads in the first place. Therefore client may use newly extracted telephone numbers to check if there is a saved session that already includes these numbers. In case there is such session the system may be configured to perform any of the following:

1. Provide a visual indication to the existence of relevant saved sessions.

2. Open the relevant said sessions.

3. Open only those windows of the relevant saved sessions that contain notes from the user.

4. Extract the comments that the user made before saving the relevant sessions and display them.

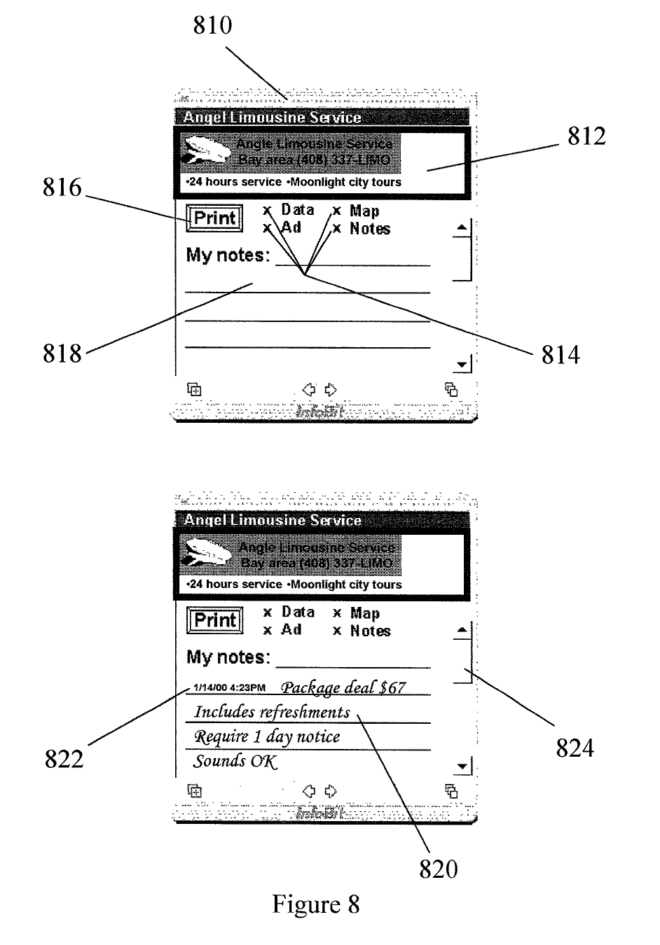

In the following preferred embodiment of the invention the windows for displaying the Expanded Ads are also configured to provide management tools for the user in his search for a service or a product. Reference is made to FIG. 8.

In the upper part of FIG. 8 an Expanded Ad 812 is displayed in a window with a numerical reference 810. Only the top part of window 810 is provided for the Expanded Ad 812. Just below Expanded Ad 812 4 check boxes 814 and print-button 816 are provided. The lower part of window 810 is dedicated for notes that the user may want to add. To add a note the user can simply place the mouse pointer at one of lines 818 and start typing his note. The notes may appear in the form shown ant the lower part of FIG. 8 by numerical reference 820. Date and time of the note (822) may be added by User Client Computer 304 as the user starts to type characters in the note section. Scroll-bar 824 is provided to view notes occupying more lines then viewable in window 810 in a single view.

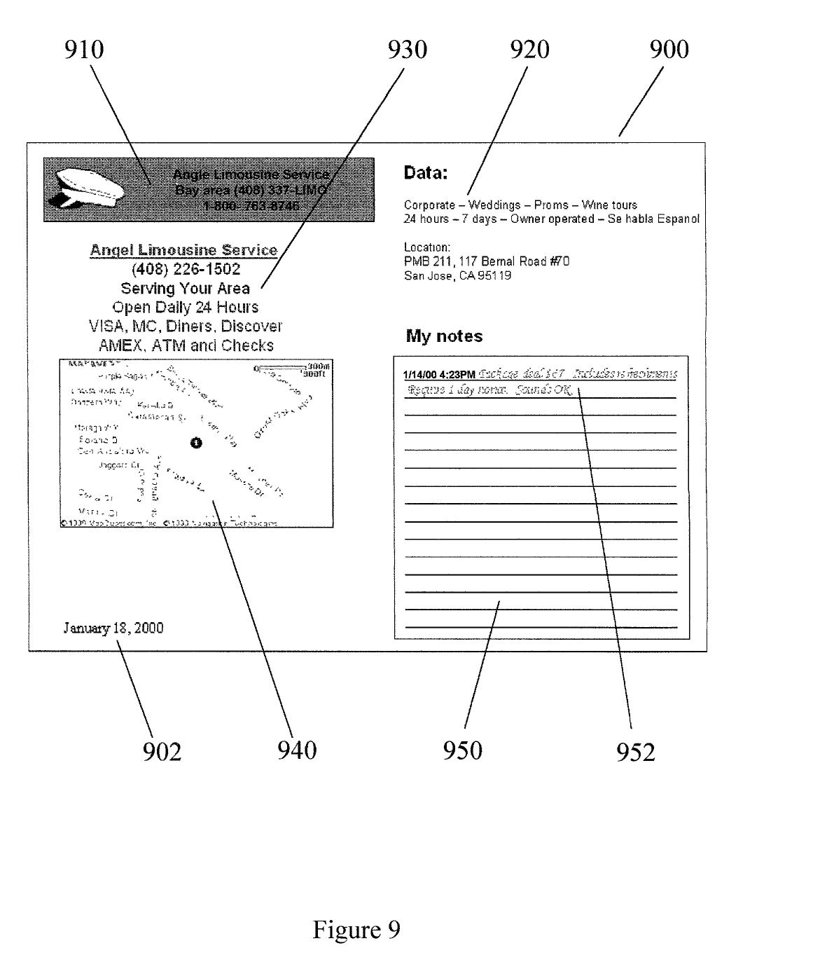

The user may print the information of window 810. The content for printing is determined by checkboxes 814. In the present example all four boxes are checked. As a result, clicking on print-button 816 will result in printing all of Data, Ad, Map and Notes. An example of such a printout is provided in FIG. 9. A letter size page may be used in landscape orientation as indicated by numerical reference 900. The Expanded Ad is printed on top-left (910). Data 920 is provided at the top-right part of page 900. More information (930) is printed below Expanded Ad 910. Further down a location map 940 is printed. A line area for hand written notes is provided at the right-bottom (950) with notes that have already been typed in with User Client Computer 300 printed at the top (952). The date in which the page was printed is available at the lowest left corner (902).

Elements such as map 940 or extra information 930 may be stored in advance in other fields of the same record in Expanded Ad Database 350 and retrieved from there when necessary. Map 940 can also be retrieved from the server of another service provider such as Infospace. It can be retrieved by Expanded Ad Server 340 that sends a map request message to the Infospace server, providing the address of the business as a parameter. The address is retrieved from the record of that business in Expanded Ad Database 350.

The following method is available with this functionality to provide the user with a managed and well-organized resource inquiry process:

1. The user receives a yellow pages result page such as the page demonstrated in FIG. 2.

2. EAs that are available for that yellow pages page are loaded automatically by a quiescence of operations made by User Client Computer 304, User Client Computer 300, Expanded Ad Server 340 and Expanded Ad Database 350 (described hereinabove).

3. The Expanded Ads and more information are presented in dedicated windows as shown in FIG. 6, numerical references 610, 612 and 614.

4. The user now reviews the displayed Expanded Ads, communicate by telephone with some of the suppliers of the merchandise and add comments to some of the windows as shown in FIG. 8, numerical reference 820.

5. At this time the user may decide to save the session and continue the process of calling businesses at a later time. This is done as described in accordance to FIG. 7B and the description hereinabove.

6. At a later time the user may access his saved session and retrieve the session exactly as it was when it was saved, including the comments he typed in during his telephone inquiries.

7. After finishing the telephone inquiry phase the user decides which businesses he wants to visit physically and print a reference document for each of them.

8. For each selected business the user checks the desired checkboxes (814 in FIG. 8).

9. The user then click on the “Print” button (816 in FIG. 8). To get the printed document of the form shown in FIG. 9.

10. The user can now take these printouts and use them as a reference and draft paper for his visit to the selected businesses.

It will be appreciated that the description of the invention provided hereinabove is provided in a way of examples and it does not limit the scope of the invention. It would be appreciated by those skilled in the art that the invention can be realized in other ways then presented hereinabove. The invention is not limited for yellow pages but can be implemented for any directory.

In another embodiment of the present invention database 350 is not required as apart of the system. The present embodiment will be described in association to a digital directory of products, i.e. a catalog, such that is displayable on computer 300 of FIG. 3 using a browser such as Internet Explorer 5.

A catalog may be built very similar to yellow pages whereas a group of products is represented in the form of items list. Each item of the list represents one product and it may consist of a text string describing, for example, the name of the product. In some cases an item in the list may contain also an image of the product or other information such as price and available colors, just as the case is for online yellow pages that may include ads.

Also, in a typical catalog, when the user clicks the hyperlink part of an item in the items list, a product page is delivered to his computer 300 of FIG. 3 and is displayed on his browser. This product page typically contains more information about the selected product such as an image, a description of the product, price, delivery time, payment methods, quantity discounts or any other relevant information.

A very typical attribute of product pages of any specific catalog is that they all made in the same format. Visually, the is title located at the same place for all product pages (such as the top-center of the page), the image is located at the same place for all the product pages (such as just below the title on the left side of the page, and any other piece of information has its' particular location that is the same for all the product pages in that catalog.

Using the fixed structure of these pages, new, pre-formatted secondary page may be constructed automatically out of this product pages. The secondary pages are preformatted to contain at least one item from the product pages. The secondary page may also contain new elements that are not available from server 320 and are provided by the software generating the secondary page, just as the case of area 820 of FIG. 8 provided for interactive notes editing performed by the user of the secondary page.

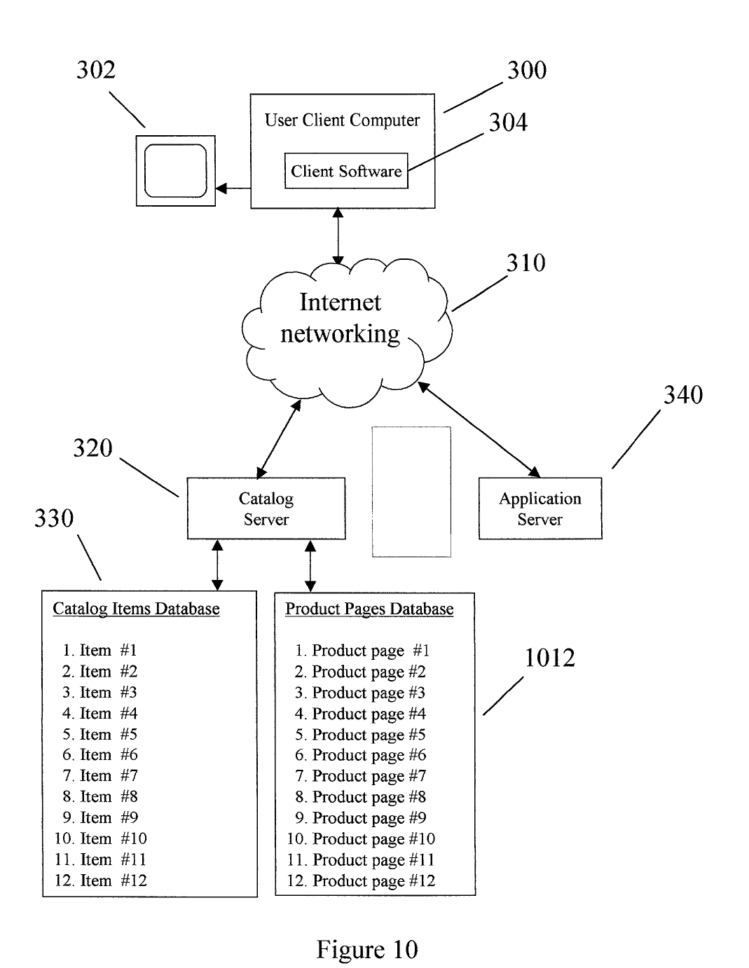

Reference is made now to FIG. 10 which is basically the system of FIG. 3 with some changes:

1. The name of server 320 is now “Catalog Server”. The task of the server is to deliver, upon request from another computer, pages of items lists (catalog pages) or product pages.

2. The name of database 330 is now “Catalog Items Database”. This database used by server 320 to build up the catalog pages to be sent to the requesting computer.

3. A new database 1012 is named “Product Pages Database” and it contains the product pages that server 320 delivers to another computer upon request. I would be appreciated that instead of containing the product pages database 1012 may contain product information that is used by server 320 to build the product page for delivery and the product pages themselves are not stored in any of these databases.

It is appreciated that database 330 and database 1012 bay be the same single database holding both the catalog items and the product pages. It is appreciated that other configurations are available (including the configuration of FIG. 3).

The software program that generates the secondary page is operative in a pre-defined procedure, configured to the specific format of the image page and the specific desired format of the secondary page. The software program receives the product page as an input and it provides the secondary page as an output.

In the following example, a product page contains, among other things, a picture of the product in a jpg format and the price of the product. The product page is in html format. Both items are requires to be embedded in the secondary page. This is done by the following steps:

1. The software program receives the product page.

2. All the product pages have the image of the product at the same location. In the html source the file is located immediately after the string <CENTER><IMG SRC=”. This string is underlined for clarity hereinabove and in the html example below that represents a part of the product page.

3. The software program searched for this string through the product page. When encountering the string the address (URL) of the image is extracted:

http://www.vendor.com/us/4/7/9/8/earnhardt00sl_{—}1.jpg

4. Then the image can be loaded by the program to be embedded in the secondary page or, alternatively, only the URL is embedded in the secondary page to retrieve the image when the page is displayed in a browser.

5. The price of the product is always located immediately following the string:

<TR><TD>Current Price:</TD><TD><h>$ (the string is underlined here and in the html example hereinbelow for clarity)

6. The software program searched for that string and when it is fount the value 6.99 that is located right following the string provides the price for the constructin of the secondary page.

7. The other elements of the secondary page are pre-built and stored as the program data. The program nay retrieve now a pre-saved secondary page that contains all the desired elements such as an area for notes or an interface and Java script that will allow the user, while displaying the finished page in his browser, to input the desired quantity of the product and the total cost will calculated and displayed for him in the page. To construct secondary page the software program inserts the new image URL (step 3 above) and the new price (step 6 above) into the pre-constructed html page.

8. The modified secondary page is then output by the software program and is delivered to the browser for display.

It would be appreciated that the methods to identify the desired elements are not limited to the methods of described above or the string that just precedes the desired part. For example, if each of the product pages contain only one jpg image the search may be for the ‘.jpg’ string.

PART OF A PRODUCT PAGE THAT CONTAINS THE
PRODUCT IMAGE:

</td><td width=“2%”>&nbsp;</td><td align=center bgcolor=“#c2bb9b”
width=“25%”><table bgcolor=dcdcdc border=0 width=
“100%” cellspacing=0><tr
align=center><td nowrap><font face=arial size=“−1”>&nbsp;
<a href=“/show/qanda?aID=50283348”>Question & Answer</a>
</font>&nbsp;</td></tr></table>
</td><td width=“1%”>&nbsp;</td><td align=right
width=“20%”>&nbsp;</td></tr>
<tr><td width=“100%” colspan=7><table border=0 cellspacing=0
width=“100%”><tr><td bgcolor=ffe566><table border=0 cellspacing=0
cellpadding=0><tr><td
height=3></td></tr></table></td></tr></table></td></tr></table><br>
<table cellpadding=0 cellspacing=4 border=0 width=“100%”>
<tr>
<td valign=top width=“90%”>
<P>
<CENTER><IMG SRC=“http://www.vendor.com/us/
4/7/9/8/earnhardt00sl_1.jpg”
WIDTH=221 HEIGHT=325></CENTER><P>
<p>
<P>

PART OF A PRODUCT PAGE THAT CONTAINS THE
PRODUCT PRICE:

<a
href=“http://clients.sales.vendor.com/show/rating?userID=
tress0099”>Comments
About Seller</a>
</TD></TR>
<TR><TD colspan=2 bgcolor=eeeeee>&nbsp;&nbsp;
<a href=“http://page.sales.vendor.com/show/qanda?aID=50283348”>Ask
Seller a
Question</a>
</TD></TR>
</TABLE>
<p>
<center><a
href=“http://edit.vendor.com/config/send_webmesg?.src=pg&.target=
tress0099”>
<img src=“http://opi.vendor.com/online?m=g&t=2&u=
tress0099” border=0
width=125 height=25></a></center>
</td>
<td valign=top>
<TABLE BORDER=0 CELLPADDING=2 width=“100%”>
<TR><TD colspan=2 BGCOLOR=“#ffe566”<B><FONT FACE=
arial>Auction
Info</FONT></B></TD></TR>
<TR><TD>Current Price:</TD><TD><b>$6.99</b></TD></TR>

Different catalogs usually have different product page formats. A different analysis is required for each such catalog. Also a different secondary page format is usually desired for different catalogs. This is accommodated by creating a database used by the software program to provide the required parameters for each catalog:

1. A string from the URL of a catalog page to identify the specific catalog (in most cases the first part of the URL is the same for all product pages of a given catalog). For example the URL may be of the type www.vendor.com/shoes/9764.html where the string vendor.com/shoes can be used to identify the specific catalog whereas 9764.html represents the specific product page, one of many in the same catalog.

2. The product page analysis requirement (what is to be extracted and by what criteria).

3. A template of the secondary page, missing only the parts extracted from the product page

During operation, the software program receives the URL of the product page. The first part, www., is striped away. Also the last part 9764.html is striped away. Then the remaining part vendor.com/shoes is compares it to the strings in the software program database. When the string is matched the relevant product page analysis instructions and the secondary page template are loaded to program to provide a complete secondary page.

In yet another embodiment of the invention, the software program may reside in Application Server 340 of FIG. 10. With this system the steps for providing a secondary page to the browser of computer 300 are as follows:

1. When the user click an item in the catalog page displayed on computer 300, Client Software 304 redirect the link address (URL) of the product page to Application Server 340. 2. The software program of Application Server 340 uses this URL to load the product page, perform the desired analysis, and generate the secondary page.

3. The secondary page is then sent to computer 300 to be displayed.

An important advantage of using Application server for that purpose and not User Client Computer 300 is provided by handling new catalogs or other changes in a single location: Application Server 340. The administrator of the system does not have to update the computers of all the clients but only Application Server 340.

In yet another embodiment of the present invention, the user may work in more then one stage. In the method described hereinabove, the single stage is clicking the item in the catalog and getting the secondary page.

In the present embodiment two stages are provided. The first stage is used buy the user to go through a “selection” process. In the selection process the secondary pages are brief and simple. They capture a small real estate of the display means (302 of FIG. 10). They may be provided in a similar look-and-feel of “cartridge” 710 of FIG. 7A and windows 610, 612 and 614 of FIG. 6. The user may select a number of items to be displayed in that form. In an even further compact form it may include only a thumbnail and the price of the product. The user uses these secondary pages to compare products and select only a part of these products for further activity (for example to send a purchase proposal to his client). After selecting the preferred products (and removing the undesired products by closing their secondary pages). A special button is provided on the frame of window 710 of FIG. 7A. When the button is clicked, Client Software 304 of FIG. 10 delivers to Server 340 of FIG. 10 the list of URLs of the product pages associated with the remaining secondary pages of the first stage. A request for a 2^{nd} stage pages is included. Application Server uses the request and the URLs to retrieve the product pages and to construct a 2nd stage secondary pages. These pages contain more information of the original product pages and more elements such as notes interface, calculation tools and a table for names and addresses.

This embodiment may comprise the following steps:

1. User requests a catalog page from Catalog Server 320.

2. Catalog Server 320 delivers a catalog page to User Client Computer 300.

3. User clicks on an item of the catalog page.

4. Client Software 304 redirects the request for the product page to Application Server 340 wit a request for a secondary page of that product page. Client Software 304 stores the URL for a later use.

5. Application Server 340 receives the URL and the request for a secondary page.

6. Application Server 340 loads the product page from Catalog Server 320, processes a secondary page and delivers the secondary page to User Client Computer 300.

7. The secondary page is displayed on display 302.

8. Steps 3 through 7 are repeated until the user is satisfied with the set of secondary pages.

9. The User now browses through the secondary pages, closing pages he does not require anymore.

10. When the User is satisfied with the remaining set of secondary pages he click a special button to request a 2^{nd} stage of secondary pages.

11. Client Software 304 sends to Application Server 340 a request for 2^{nd} stage of secondary pages and includes the list of URLs stored in step 4 above.

12. Application server receives the request with the list of URLs and generates a 2nd stage of secondary pages for these URLs.

13. The 2nd stage of secondary pages are sent to User Client computer 300 for display, interaction and any other use.

It is appreciated that in this embodiment the software program that generates the secondary pages has an expanded database of data. For each URL (a catalog product page) it has two different templates. The first template is used for the secondary page of the first stage and the second template is used for the secondary page of the 2nd stage.

It would also be appreciated that more then two stages can be applied.

It would also be appreciated that the system structure is not limited to the description provided hereinabove. For example, Application computer 340 may be eliminated and the software program that creates the secondary pages may reside in User Client Computer 300 or in Catalog Server 320. Also, for example, if the software program software program that creates the secondary pages has a direct access to the database (or databases) of Catalog Server 320, the element required to build the secondary page (such as images and prices) can be retrieved by that software directly from the records of the database containing these elements.

It is also appreciated that the complete method can be set to work with a single computer serving the user, containing Catalog Database 330 (and if the product pages are pre-built it contains also Product pages Database 1012), it contains the software program that generates the secondary pages, it contains Client Software 304 and display means 302.

It will be appreciated that the description of the invention provided hereinabove is provided in a way of examples and it does not limit the scope of the invention. It would be appreciated by those skilled in the art that the invention can be realized in other ways then presented hereinabove. The invention is not limited for yellow pages but can be implemented for any directory.

The scope of the invention is defined only by the claims.

The terms used in the claims should be interpreted in the broad sense. For example:

1. NETWORK refers to any communication network such as Internet or LAN. But it can also refer to computer internal communication channels when all the component of the system are operative on a single computer.

2. DTABASE may be interpreted as an Oracle database or SQL server available from Microsoft that include high functionality and management tools, but it also can be interpreted as a simple array containing the data. The interpretation should be made according to the context.

3. SERVER may be interpreted as a hardware computer with any server software but in can be interpreted as the software alone. In this sense two or more servers may reside on the same computer.

4. CLIENT may refer to the combination of computer and client software but also to the client software alone. Clients and servers may be interpreted as all residing on a single computer.

5. The terms mentioned above are used, in some contexts, to describe functionality and not a physical or abstract object.

6. For example, a TELPHONE NUMBER may also be interpreted as a fax number.

7. A NAME may be a business name or a person's name.

8. A PRODUCT DIRECTORY may contain only names or catalog numbers of products or may include more information such as images and prices.

9. A SECONDARY PAGE is used in the claims as described hereinabove.

10. A PRODUCT PAGE is used to describe any digital file containing information on a product, a service, a place, or any other topic

11. The word PRODUCT represents any topics such as a product, a service and a place.

1. A computer based system comprising:
A database containing a product directory and product information, and;
At least one computer, said computer configured to provide product pages out of said database containing a product directory, and;
A user interface including means for selecting items from said product directory, and;
A software program for (automatically) generating digital document containing at least one item from said database that represents information of a specific product, and at least one item representing general information that is not related directly to said specific product, and;
The step of displaying said digital document on display means.

2. A computer based system comprising:
A database containing a product directory and product information, and;
At least one computer, said computer configured to provide product pages out of said database containing a product directory, and;
A user interface including means for selecting items from said product directory, and;
A software program for (automatically) generating digital document containing at least one item from said database that represents information of a specific product, and at least one item representing general information that is not related directly to said specific product, and;
The step of displaying said digital document on display means, and;
the steps of loading a product page, and;
The step of analyzing the product page, and;
The step of using the results of said analysis to extract pre-determined information from said product page, and;
The step of embedding said extracted information in a newly created digital document.

3. The system according to claims 1 and 2 and whereas the steps of extracting information and generating digital documents is applied to at least two product pages, said at least two product pages are of the same format but contain at least one different information item.

4. The system according to claims 1 through 3 whereas said digital document contains at least one field enabling any user add comments to said field without effecting the rest of the file.

5. The system according to claim 1 through 4 and including at least two different product directories, and;
At least two different schemes for creating said new digital document, and;
the step of applying at least one of said schemes to at least one product directory for creating said new digital document, and;
the step of applying at least one other of said schemes to at least one other product directory for creating said new digital document

6. A computer based system comprising:
A database containing a product directory and product information, and;
At least one computer, said computer configured to provide product pages out of said database containing a product directory, and;
A user interface including means for selecting items from said product directory, and;
A software program for (automatically) generating digital document containing at least one item from said database that represents information of a specific product, and at least one item representing general information that is not related directly to said specific product, and;
The step of displaying said digital document on display means.

7. A computer based system comprising:
A database containing a product directory and product information, and;
At least one computer, said computer configured to provide product pages out of said database containing a product directory, and;
A user interface including means for selecting items from said product directory, and;
A software program for (automatically) generating digital document containing at least one item from said database that represents information of a specific product, and at least one item representing general information that is not related directly to said specific product, and;
The step of displaying said digital document on display means, and;
including a first scheme for creating said new digital document, and;
At least a second scheme for creating said new digital document, and;
The step of creating a first digital document from according to a first scheme, and
The step of creating at least a second digital document, for the same product, according to said at least second scheme.
